(19) United States
(12) Patent Application Publication
(10) Pub. No.: US 2009/0159613 A1
(43) Pub. Date: Jun. 25, 2009

(54) DISPENSER AND FLEXIBLE CONTAINER FOR LIQUID FOOD PRODUCT

(75) Inventor: Gerald A. Rusch, Fond du Lac, WI (US)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: SERVER PRODUCTS, INC., Richfield, WI (US)

(21) Appl. No.: 12/337,303

(22) Filed: Dec. 17, 2008

Related U.S. Application Data
(60) Provisional application No. 61/014,988, filed on Dec. 19, 2007.

(51) Int. Cl. B65D 35/28; B65D 35/56; B67D 5/42

(52) U.S. Cl. 222/95; 222/105; 222/386.5

(57) ABSTRACT

A dispensing assembly for dispensing a liquid food product includes a flexible container received within a dispenser. An actuating structure within the dispenser exerts a force on the flexible container to dispense the food product through a nozzle mounted to the dispenser. A dispensing spout of the flexible container forms a seal with an inner wall of the nozzle to prevent the back flow of liquid food product during dispensing of the food product.

### CROSS REFERENCE TO RELATED APPLICATION

The present application relates to and claims priority of U.S. Provisional Patent Application Ser. No. 61/014,988, filed Dec. 19, 2007.

### BACKGROUND

The present disclosure generally relates to a dispenser assembly for dispensing liquid food product. More specifically, the present disclosure relates to a dispensing assembly that includes a collapsible, flexible container including the liquid food product and a dispenser that receives the flexible container and includes an actuator for pushing the food product out of the flexible container for dispensing.

### SUMMARY

The present disclosure relates to a dispensing assembly including a flexible container having an outer wall that defines an open interior for receiving and retaining the liquid food product. The flexible container is sized to be received within an open interior of a dispenser. The dispenser receives a nozzle that is connected to the dispenser and is positioned to receive a dispensing spout of the flexible container. When an actuating structure of the dispenser compresses the flexible container, the liquid food product flows out of the dispensing spout, thereby causing the dispensing spout to press against an inner wall of the nozzle to create a fluid seal therebetween.

The dispenser of the present disclosure receives a cover member that can be removed from an outer housing of the dispenser. The cover member and the outer housing combine to receive the flexible container filled with food product to be dispensed. When the flexible container is received within the open interior of the dispenser housing, the dispensing spout of the flexible container extends through an attachment collar formed on the cover member. The cover member and attachment collar are sized such that the dispensing spout extends past an outer surface of the attachment collar.

When the cover member is installed on the dispenser, a nozzle is positioned in contact with the outer surface of the attachment collar. The nozzle is sized such that the outer diameter of the dispensing spout closely corresponds with the inner diameter of the nozzle.

Once the nozzle is positioned on the attachment collar, a retaining ring is tightened along the attachment collar to secure the nozzle to the cover member. Preferably, the nozzle includes a one-way control valve that allows food product to only flow out of the nozzle.

During dispensing of the liquid food product, the actuating structure of the dispenser compresses the flexible container to force food product out of the dispensing spout. In one embodiment, the actuating structure is a movable piston contained within the open interior of the dispenser.

As the piston compresses the flexible container, the fluid flow out of the container created by the compression of the flexible container create a radial force to press the dispensing spout outward and into contact with an inner surface of the nozzle. The radial force created by the fluid flow creates a seal between the dispensing spout and the nozzle to prevent leakage of the food product into the open interior of the dispenser.

### BRIEF DESCRIPTION OF THE DRAWINGS

The drawings illustrate the best mode presently contemplated of carrying out the disclosure. In the drawings:

FIG. 1 is a perspective view illustrating a food product dispenser constructed in accordance with the present disclosure;

FIG. 2 is a side view of the food product dispenser;

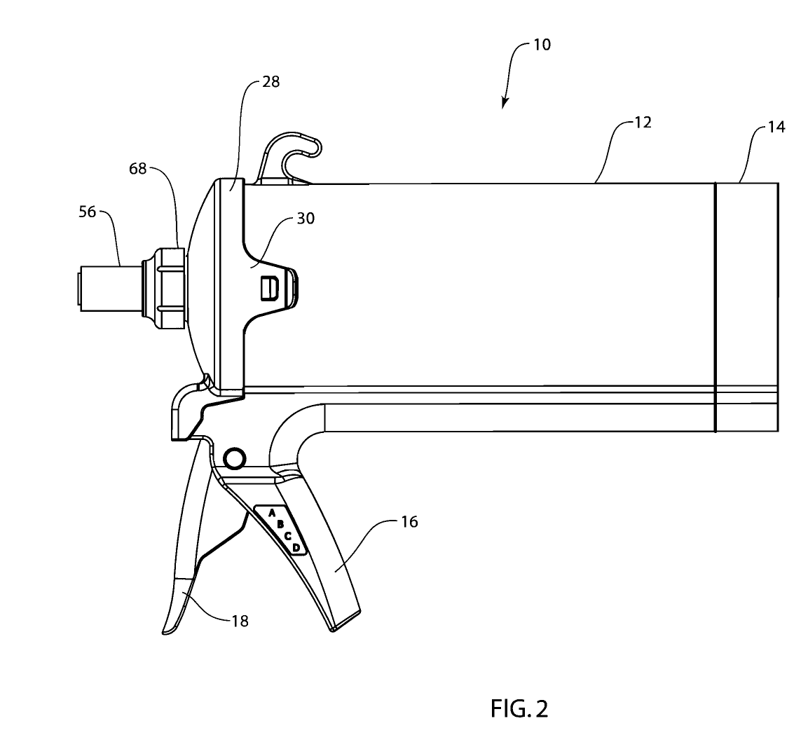

FIG. 3 is a side, exploded view of the food product dispenser including the dispensing nozzle, control valve and retainer in an exploded position;

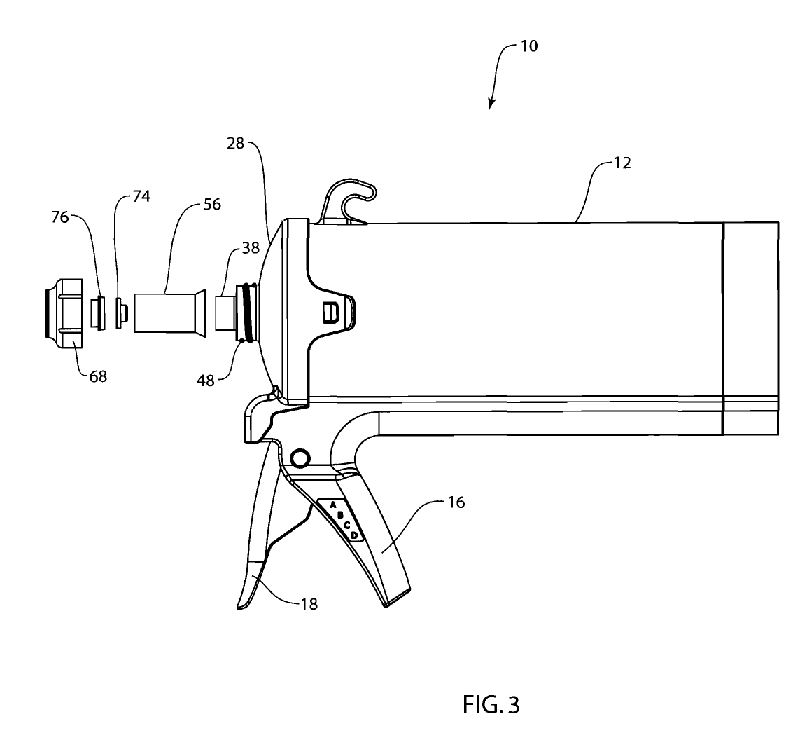

FIG. 4 is a section view similar to FIG. 3;

FIG. 5 is a magnified, section view similar to FIG. 4 showing the magnified view of the cover member and external nozzle;

FIG. 6 is a section view illustrating the interaction between the nozzle and the dispensing spout of the flexible container to allow dispensing of the food material without leaking; and

FIG. 7 is a perspective view of the dispensing pouch;

### DETAILED DESCRIPTION OF THE DRAWINGS

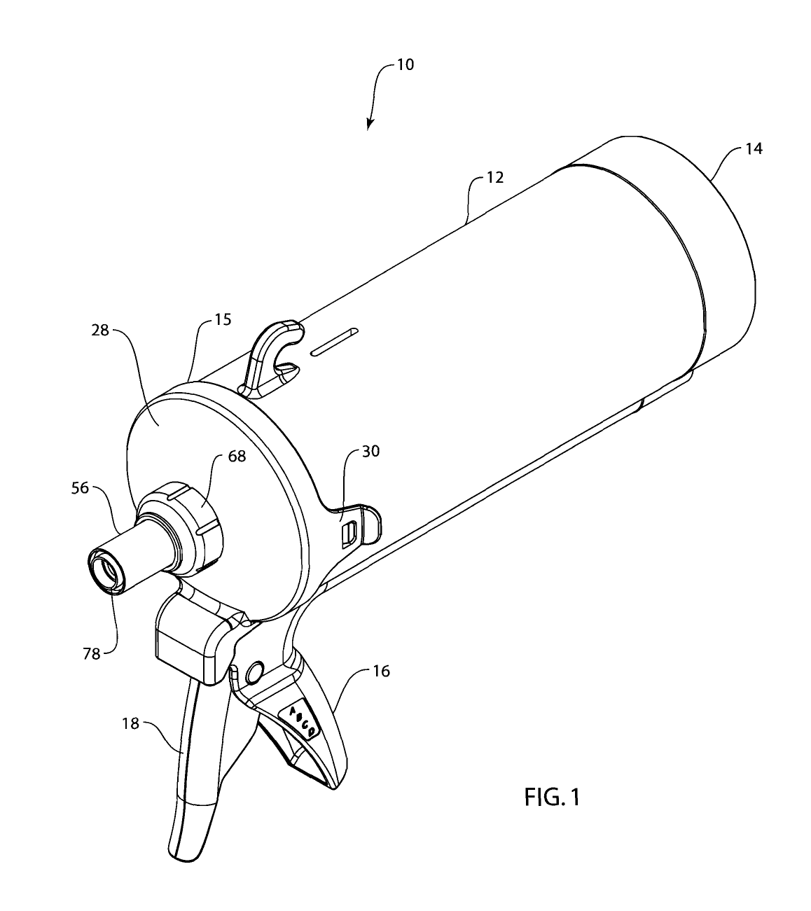

FIG. 1 illustrates a food product dispenser 10 that is particularly useful in dispensing liquefied food products, such as condiments, whipped cream toppings, sauces or other similar types of liquefied food products. The food product dispenser 10 generally includes a cylindrical outer housing 12 that extends from a back end 14 to a front end 15. In the embodiment shown in FIG. 1, the food product dispenser 10 includes a handle 16 and a user-actuated trigger 18. Although the handle 16 and trigger 18 are shown positioned near the front end 15, the handle 16 and trigger 18 could be moved closer to the center or rear of the housing 12 to provide better weight distribution of the dispenser 10.

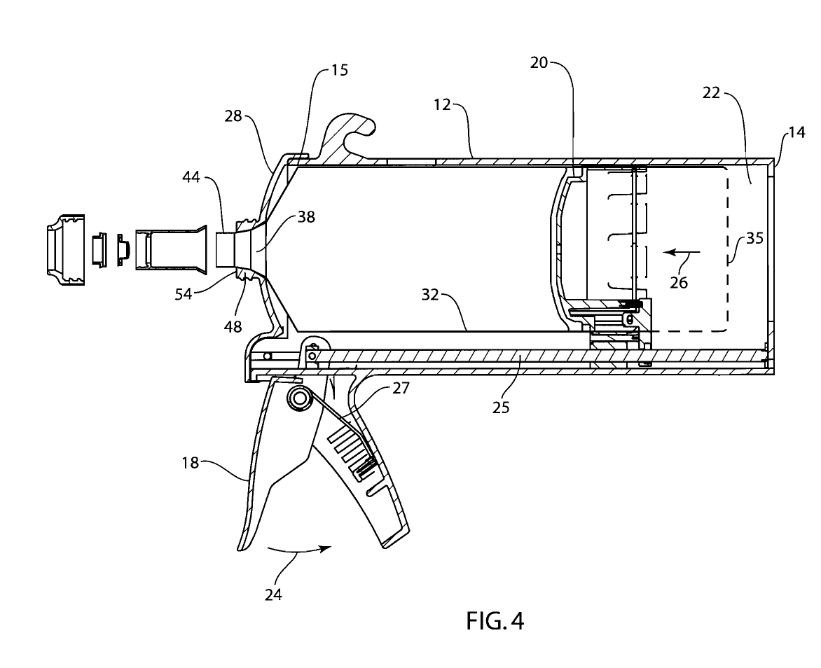

As can best be seen in FIG. 4, the trigger 18 forms part of an actuating structure of the product dispenser 10. Specifically, the trigger 18 is coupled to a piston 20 that is movable within the open interior 22 of the cylindrical outer housing 12. The actuating structure functions such that upon each movement of the trigger 18 in the direction shown by arrow 24, an actuation rod 25 moves the piston 20 in the direction shown by arrow 26 toward the front end 15. A bias spring 27 returns the trigger to the position shown. The operation of the trigger 18 to move the piston 20 along the open interior 22 of the outer housing 12 is a well known, conventional operation that has been used in other industries, such as for dispensing caulk from a cardboard container.

Referring back to FIG. 1, the front end 15 of the outer housing 12 receives a removable cover 28 that is retained on the outer surface of the outer housing 12 by a pair of latches 30. The outer cover 28 can be removed to reload the dispenser with a flexible product container or pouch including the food product to be dispensed, as will be described in detail below.

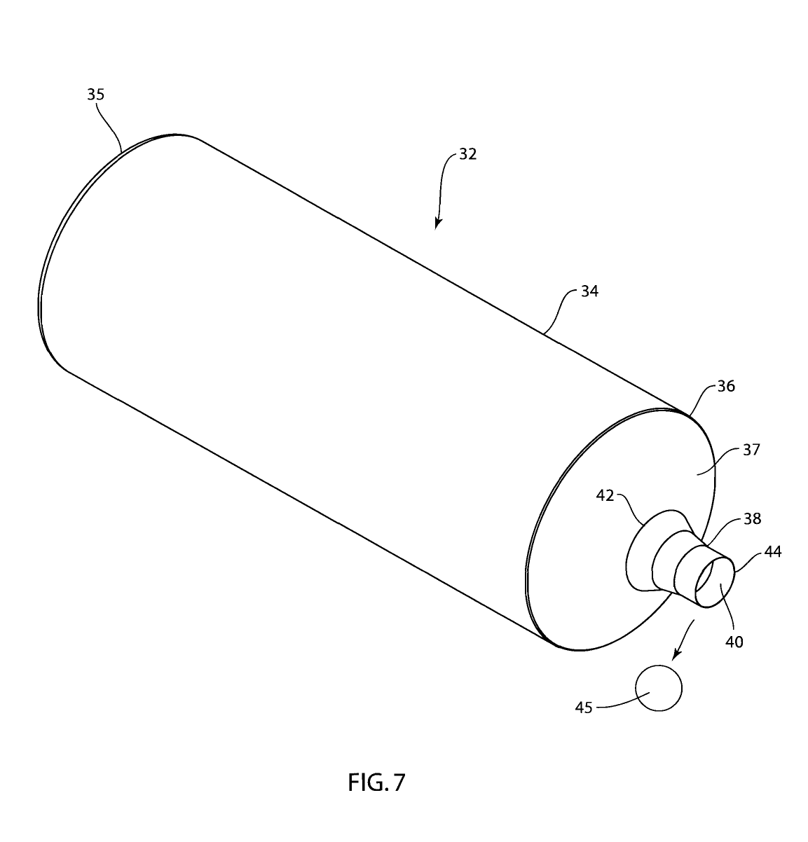

Referring now to FIG. 7, the food product dispenser 10 is sized to receive a flexible container 32 that can be filled with a liquid food product to be dispensed. The flexible container 32 is preferably formed from a collapsible, flexible plastic material and includes a generally tubular main body 34 extending between a back end 35 and a front end 36. The outer wall that defines the flexible container 32 further defines a sloping front surface 37 that tapers to a dispensing spout 38. As illustrated in FIG. 7, the dispensing spout 38 includes a dispensing opening 40 that is generally aligned along the central axis of the flexible container 32. The dispensing opening 40 includes an end seal 45 that seals the open interior defined by the flexible container 32. When it is desired to dispense the liquid food product from the flexible container 32, the end seal 45 is removed from the dispensing opening 40, as shown in FIG. 7.

As illustrated in FIG. 7, the dispensing spout 38 includes a plurality of individual sections that create a taper in the dispensing spout 38 from a base 42 to the outermost edge surface 44 that defines the dispensing opening 40. Although separate tapered sections are shown in FIG. 7 to illustrate the taper from the base 42 to the outer edge 44, it is contemplated that the dispensing spout 38 could have various other configurations while operating within the scope of the present disclosure.

Prior to opening, the dispensing opening 40 is sealed by the end seal 45, which may be a removable piece of the plastic material. With the end seal 45 in place, the flexible container 32 completely encloses the food product contained within the flexible container 32. When the food product within the flexible container 32 is to be dispensed, the end seal 45 is removed, which uncovers the dispensing opening 40. Prior to removal, the end seal 45 prevents contamination of the food product within the flexible container 32.

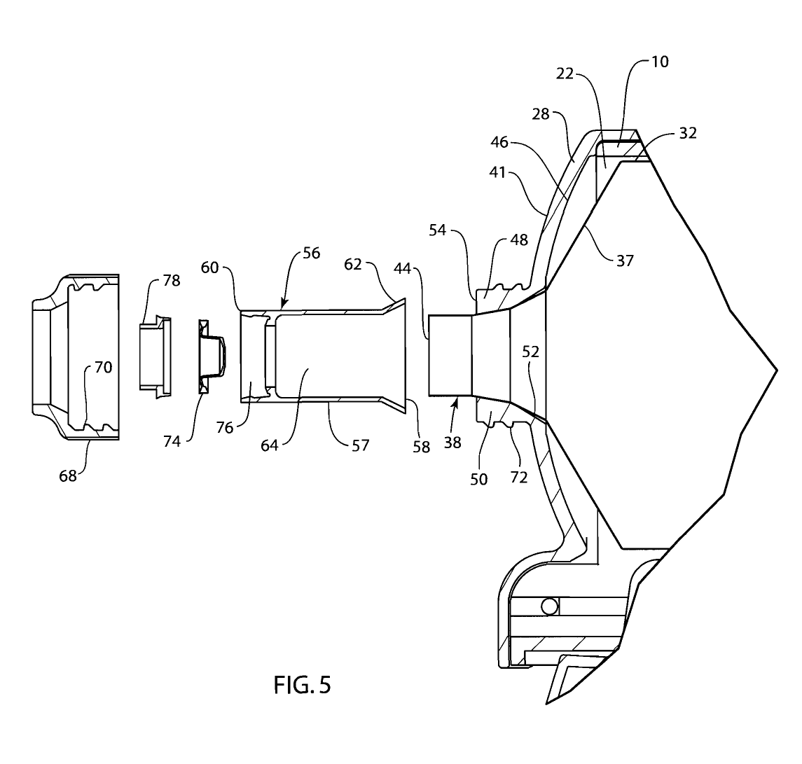

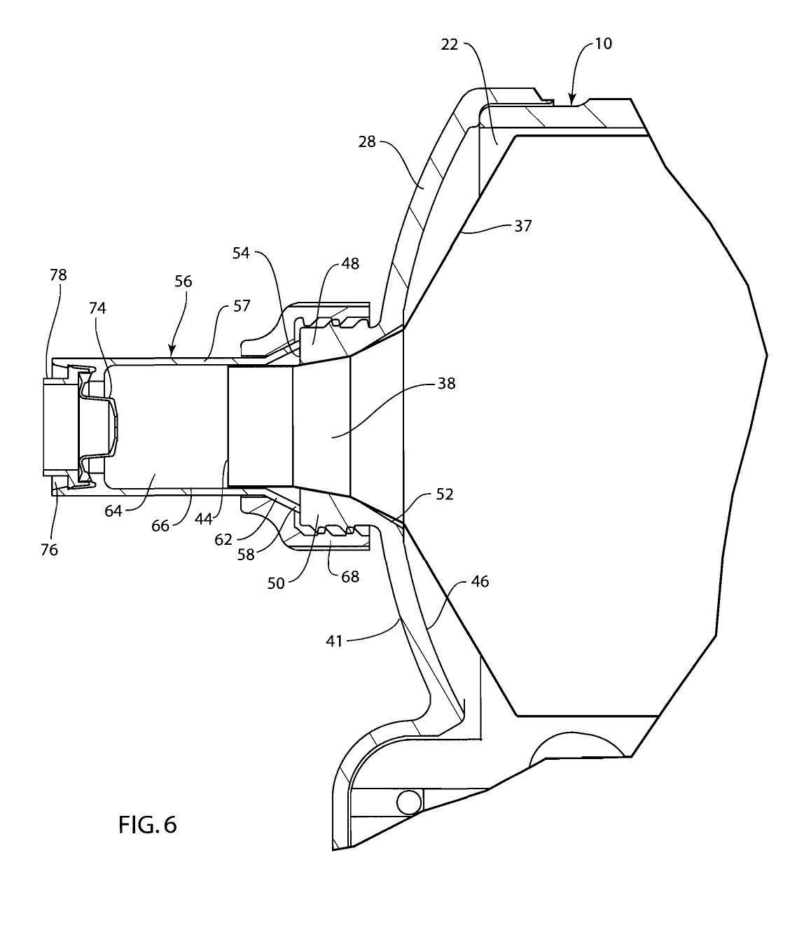

Referring now to FIGS. 5 and 6, when the flexible container 32 is positioned within the open interior 22 of the dispenser, the cover member 28 surrounds the frustoconical front surface 37 of the flexible container 32. As illustrated, the cover member 28 has a generally curved configuration such that an inner wall 46 of the cover member is spaced from the front surface 37.

When the flexible container 32 is received within the dispenser 10, the dispensing spout 38 extends through an attachment collar 48 formed on the outer surface 41 of the cover member 28. The attachment collar 48 is defined by an outer wall 50 having a tapered inner surface 52 that generally corresponds to the taper of the dispensing spout 38. As illustrated in FIG. 5, the outer end 44 of the dispensing spout 38 extends past the outer surface 54 of the attachment collar.

The dispensing assembly 10 further includes a nozzle 56 that is received on the cover member 28. The nozzle 56 includes an outer wall 57 that extends from a first end 58 to a second end 60. The outer wall 57 includes an outward taper 62 near the first end 58. The outer wall 57 defines an open flow passageway 64.

As illustrated in FIG. 6, when the nozzle 56 is attached to the cover member 28, the first end 58 contacts the outer surface 54 of the attachment collar 48. When in this position, the outer end surface 44 of the dispensing spout 38 extends past the outward taper 62 and into the flow passageway 64. As illustrated in FIG. 6, the outer diameter of the dispensing spout 38 near the outer end 44 closely corresponds to the inner diameter of the nozzle 56, as defined by the outer wall 57. As will be described in detail below, when food product is dispensed from the dispenser assembly, the pressure of the food product exerts a radial outward force against the flexible material that forms the dispensing spout 38, thereby causing contact between the outer diameter of the dispensing spout and the inner surface 66 of the nozzle 56.

Referring back to FIG. 5, the nozzle 56 is held in contact with the attachment collar 48 by a retainer ring 68. The retainer ring 68 includes a threaded inner surface 70 that interacts with a corresponding series of external threads 72 formed along the outer surface of the attachment collar 48. When the retainer ring 68 is tightened onto the attachment collar 48, the retainer ring 68 holds the nozzle 52 in place, as illustrated in FIG. 6. As can be understood in FIGS. 5 and 6, the nozzle 56 can be removed from the cover member 28 by simply reversing direction of rotation of the retainer ring 68.

Referring back to FIG. 5, the nozzle 56 receives a control valve 74 preferably formed from a silicone material. The control valve 74 is held within a receiving cavity 76 formed as part of the nozzle 56 by a retainer 78. The control valve 74 provides for one-way flow of the liquid food product out of the nozzle 56 and is a conventional valve currently available. As illustrated in FIG. 6, the retainer 78 locks into the receiving cavity 76 to prevent removal of the control valve 74 from the nozzle 56.

Operation of the food product dispenser 10 will now be described with reference to the drawing figures.

Initially, the user receives the flexible container 32, such as shown in FIG. 7, filled with the liquid food product to be dispensed. Once the user has received the flexible container 32 filled with food product, the pair of latches 30 on the front cover 28 are released and the front cover 28 is removed from the main body of the outer housing 12. Once the cover 28 has been removed, the internal piston 20, as best shown in FIG. 4, is retracted back toward the back wall 14 to maximize the size of the open interior. As shown by the dashed lines of FIG. 4, the length of the flexible container 32 is less than the length of the outer housing 12 such that the back end 35 of the flexible container 32 is spaced slightly from the back end 14. When the piston 20 is in its fully retracted position, the piston 20 only slightly compresses the flexible container 32.

Once the flexible container 32 is inserted into the open interior 22 of the outer housing 12, the cover member 28 is reattached to the outer housing 12. When the cover member 28 is attached to the outer housing 12, the outer end 44 of the dispensing spout 38 extends past the outer surface 54 of the attachment collar 48.

Once the flexible container 32 is positioned as shown in FIG. 5, the end seal 45 (FIG. 7) is removed from the dispensing spout 38 to uncover the dispensing opening 40. The end seal 45 remain in place until the flexible container 32 is positioned within the food product dispenser to prevent spillage of the liquid food product.

Referring back to FIG. 5, when the dispensing spout 38 is positioned as shown, the nozzle 56 is moved into position such that the first end 58 contacts the outer surface 54 of the attachment collar 48. The outward taper 62 of the outer wall 58 facilitates positioning of the nozzle 56 over the dispensing spout 38.

Once the nozzle has been positioned over the dispensing spout 38, the retainer ring 68 slides over the nozzle 56 such that the threaded inner wall 70 engages the external threads 72 on the attachment collar. The retainer ring 68 is rotated to tighten the retainer ring 68 along the attachment collar 48.

Once the nozzle 56 has been securely attached to the cover member 28, the user can grasp the handle 16 and depress the trigger 18 with a single hand to move the piston 20 in the direction illustrated by arrow 26 in FIG. 4 to compress the flexible container 32. In the position shown in FIG. 4, the flexible container 32 is partially compressed from its extended position shown by dashed lines. The user can continue to depress the trigger 18 to move the piston 20 toward the cover member 28 to dispense the entire contents of the flexible container 32.

Referring back to FIG. 6, when food product is being dispensed from the food product dispenser 10, the fluid pressure created by movement of the piston within the open interior of the food product dispenser creates a radial, outward force at the outer end 44 of the dispensing spout 38. The radial, outward force causes the flexible material that forms the dispensing spout 38 to flex outward and into contact with the inner surface 66 of the nozzle 56. This outward force creates a seal between the flexible material that forms the dispensing spout 38 and the inner surface 66 of the nozzle 56. The pressure seal created between the dispensing nozzle 38 and the nozzle 56 prevents the back flow of material from the flow passageway 68 into the open interior 22 of the food product dispenser 10.

Once the entire contents of the flexible container 32 have been dispensed, the retainer ring 68 is removed from the cover member 28, which also releases the nozzle 56. With the nozzle and retainer ring removed, the latches on the cover member 28 are released and the cover member is removed from the food product dispenser. Once the cover member has been removed, the empty flexible container 32 can be removed through the front end 15 of the outer housing 12 and another full product container inserted into the open interior 22.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

I claim:

1. A dispensing assembly for a liquid food product, comprising:
a collapsible, flexible container having an outer wall defining an open interior for receiving the food product and a dispensing spout having a dispensing opening;
a dispenser having an open interior for receiving and holding the flexible container, the dispenser having an actuating structure engageable with the flexible container for compressing the flexible container and forcing the liquid food product out of the dispensing spout; and
a nozzle received on the dispenser and positioned to receive the dispensing opening of the flexible container, wherein the nozzle defines a flow passageway having an inner surface sized to engage the dispensing spout during dispensing of the food product.

2. The dispensing assembly of claim 1, wherein the dispenser includes a removable cover connected to an outer housing that defines the open interior of the dispenser.

3. The dispensing assembly of claim 2, wherein the cover member includes an attachment collar that engages the nozzle and is sized to receive the dispensing spout of the flexible container.

4. The dispensing assembly of claim 1, wherein the nozzle includes a control valve operable to permit one-way flow of the liquid flood product out of the nozzle.

5. The dispensing assembly of claim 2, wherein the actuating structure of the dispenser includes a piston movable toward the cover member to compress the flexible container when the flexible container is positioned within the dispenser.

6. The dispensing assembly of claim 3, further comprising a retainer ring receivable on the attachment collar to secure the nozzle to the cover member.

7. The dispensing assembly of claim 1, wherein the dispensing opening of the flexible container includes an end seal, wherein the end seal is removed before dispensing food product from the flexible container.

8. The dispensing assembly of claim 5, wherein the movement of the piston against the flexible container creates fluid pressure to force the dispensing spout of the flexible container against the inner surface of the nozzle to prevent leakage of the food product past the dispensing spout.

9. A dispensing assembly for liquid food product, comprising:
a collapsible, flexible container having an outer wall defining an open interior for receiving the food product and a dispensing spout having a dispensing opening;
a dispenser for receiving and holding the flexible container, the dispenser having an open interior including an actuating structure engageable with the flexible container for forcing the liquid food product out of the dispensing spout;
a cover member removably connected to the outer housing, the cover member including an attachment collar having an inner surface sized to receive the dispensing spout of the flexible container; and
a nozzle coupled to the attachment collar of the cover member and positioned to receive the dispensing opening of the flexible container, wherein the nozzle defines a flow passageway having an inner surface sized to engage the dispensing spout during dispensing of the food product.

10. The dispensing assembly of claim 9 wherein the nozzle includes a control valve operable to permit one-way flow of liquid food product out of the nozzle.

11. The dispensing assembly of claim 9, wherein the actuating structure of the dispenser includes a piston movable toward the cover member to compress a flexible container when the flexible container is positioned within the dispenser.

12. The dispensing assembly of claim 11 further comprising a retainer ring receivable on an outer surface of the attachment collar to secure the nozzle to the cover member.

13. A method of dispensing a liquid food product, the method comprising the steps of:
providing a flexible container filled with the liquid food product, the flexible container including a dispensing spout having a dispensing opening;
providing a dispenser having an open interior and an actuating structure movable within the open interior;
positioning the flexible container filled with food product within the open interior of the dispenser;
attaching a cover member to the dispenser such that the dispensing spout of the flexible container extends through an attachment collar of the cover member;
positioning a nozzle on the cover member such that the dispensing spout is received within an outer wall of the nozzle; and
moving the actuating structure into engagement with the flexible container to force the liquid food product out of the dispensing opening of the dispensing spout, wherein the flow of the liquid food product creates a fluid pressure to force the dispensing spout against an inner surface of the nozzle during dispensing of the liquid food product.

14. The method of claim 13 further comprising the step of providing a retaining ring to secure the nozzle to the attachment collar of the cover member.

15. The method of claim 13, wherein the actuating structure includes a piston movable back and forth within the outer housing, wherein the step of dispensing the food product includes moving the piston toward the cover member to compress the flexible container.
